(19) United States
(12) Patent Application Publication
(10) Pub. No.: US 2025/0007581 A1
(43) Pub. Date: Jan. 2, 2025

(54) METHOD AND DEVICE FOR SUPPORTING MULTIPLE ACCESS BY USING SWITCH NETWORK

(71) Applicants: Samsung Electronics Co., Ltd., Gyeonggi-do (KR); Industry-Academic Cooperation Foundation, Yonsei University,, Seoul (KR)

(72) Inventors: Seunghyun LEE, Gyeonggi-do (KR); Kwonjong LEE, Gyeonggi-do (KR); Hyungje LEE, Seoul (KR); Chahyeon EOM, Seoul (KR); Chungyong LEE, Seoul (KR); Jieun YU, Seoul (KR)

(21) Appl. No.: 18/292,109

(22) PCT Filed: Jul. 27, 2022
(86) PCT No.: PCT/KR2022/011067

§ 371 Date: Jan. 25, 2024

(30) Foreign Application Priority Data
Jul. 28, 2021 (KR) 10-2021-0099488

(51) Int. Cl. H04B 7/06; H04L 25/02; H04W 72/23

(52) U.S. Cl. CPC H04B 7/0626; H04L 25/0224; H04W 72/23

(57) ABSTRACT

The present disclosure relates to a 5^{th} generation (5G) or 6^{th} generation (6G) communication system for supporting higher data rates after a 4^{th} generation (4G) communication system such as long term evolution (LTE). An embodiment of the present disclosure provides a method by which a base station (BS) supports multiple accesses of a plurality of user equipments (UEs) by using a switch network (SN). The method may include obtaining channel state information (CSI) from the plurality of UEs, identifying a plurality of subarrays (SAs) formed from an antenna array having a plurality of antenna elements, identifying at least one SA to be allocated to the plurality of UEs from among the plurality of SAs, determining a structure of a SN corresponding to each of the plurality of UEs, and supporting the multiple accesses of the plurality of UEs, based on the determined structure of the SN.

### TECHNICAL FIELD

The present disclosure relates to a wireless communication system, and to a method and apparatus for supporting multiple accesses by using a switch network.

### BACKGROUND ART

Considering the development of wireless communication from generation to generation, technologies have been developed mainly for services targeting humans, such as voice calls, multimedia services, data services, and the like. Following the commercialization of 5^{th} generation (5G) communication systems, it is expected that connected devices that have been exponentially growing will be connected to communication networks. Examples of things connected to networks may include vehicles, robots, drones, home appliances, displays, smart sensors connected to various infrastructures, construction machines, factory equipment, and the like. Mobile devices are expected to evolve in various form-factors such as augmented reality glasses, virtual reality headsets, hologram devices, and the like. In order to provide various services by connecting hundreds of billions of devices and things in the 6^{th} generation (6G) era, there have been ongoing efforts to develop enhanced 6G communication systems. For these reasons, 6G communication systems are referred to as beyond-5G systems.

6G communication systems, which are expected to be commercialized around 2030, will have a peak data rate of tera (i.e., 1,000 giga)-level bps and radio latency less than 100 psec. That is, the 6G communication systems will be 50 times as fast as 5G communication systems and have one tenth the radio latency of 5G.

In order to achieve such a high data rate and ultra-low latency, it has been considered to implement the 6G communication systems in a terahertz band (for example, 95 GHz to 3 THz bands). It is expected that, due to more severe path loss and atmospheric absorption in the terahertz bands than those in mmWave bands introduced in 5G, technologies capable of securing the signal transmission distance, that is, coverage, will become more important. It is necessary to develop, as major technologies for securing the coverage, radio frequency (RF) elements, antennas, novel waveforms having better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, in order to improve the coverage of terahertz-band signals, there has been ongoing discussion about new technologies such as metamaterial-based lenses and antennas, a high-dimensional spatial multiplexing technology using orbital angular momentum (OAM), reconfigurable intelligent surface (RIS), and the like.

Moreover, in order to improve spectral efficiency and overall network performance, the following technologies have been developed for 6G communication systems: a full-duplex technology for enabling an uplink transmission and a downlink transmission to simultaneously use the same frequency resource at the same time; a network technology for using satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; use of artificial intelligence (AI) in wireless communication for improvement of overall network operation by using AI in a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in the 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of the 6G communication systems in hyper-connectivity, including person to machine (P2M) as well as machine to machine (M2M), will facilitate the next hyper-connected experience. In more detail, it is expected that services such as truly immersive extended reality (XR), high-fidelity mobile hologram, and digital replication could be provided through the 6G communication systems. In addition, services such as remote surgery for security and reliability enhancement, industrial automation, and emergency response will be provided through the 6G communication system, such that the technologies could be applied in various fields such as industry, medical care, automobiles, home appliances, and the like.

### DISCLOSURE

### Technical Problem

An embodiment of the present disclosure may provide a technology capable of minimizing power consumption of a base station (BS) while satisfying a quality of service (QoS) of each of user equipments (UEs) in a wireless communication system that supports multi-UE accesses by using a switch network (SN).

An embodiment of the present disclosure may provide a technology by which a UE can predict a channel state and provide a feedback of channel state information in a wireless communication system that supports multi-UE accesses by using a SN.

The technical problems of the present disclosure are not limited to the aforementioned technical features, and other unstated technical problems may be inferred from embodiments below.

### Technical Solution

Provided is a method, performed by a base station (BS), of supporting multiple accesses of a plurality of user equipments (UEs) by using a switch network (SN) in a wireless communication system, the method being disclosed as a technical means to achieve the aforementioned technical problems and including obtaining channel state information (CSI) from the plurality of UEs, identifying a plurality of subarrays (SAs) formed from an antenna array having a plurality of antenna elements, identifying at least one SA to be allocated to the plurality of UEs from among the plurality of SAs, determining a structure of a first SN corresponding to at least one SA to be allocated to a first UE from among the plurality of UEs, determining a structure of a second SN corresponding to at least one SA to be allocated to a second UE from among the plurality of UEs, and supporting the multiple accesses of the plurality of UEs, based on the determined structure of the first SN and the determined structure of the second SN.

Provided is a base station (BS) configured to support multiple accesses of a plurality of user equipments (UEs) by using a switch network (SN) in a wireless communication system, the BS being disclosed as a technical means to achieve the aforementioned technical problems and including a transceiver and at least one processor. The at least one processor may be configured to, obtain, via the transceiver, channel state information (CSI) from the plurality of UEs, identify a plurality of subarrays (SAs) formed from an antenna array having a plurality of antenna elements, identify at least one SA to be allocated to the plurality of UEs from among the plurality of SAs, determine a structure of a first SN corresponding to at least one SA to be allocated to a first UE from among the plurality of UEs, determine a structure of a second SN corresponding to at least one SA to be allocated to a second UE from among the plurality of UEs, and support the multiple accesses of the plurality of UEs, based on the determined structure of the first SN and the determined structure of the second SN.

Provided is a wireless communication user equipment (UE) disclosed as a technical means to achieve the aforementioned technical problems and including a transceiver and at least one processor. The at least one processor may be configured to receive Type-S channel state information reference signal (CSI-RS) configuration information and feedback configuration information from a base station (BS) via the transceiver. The at least one processor may be configured to receive a Type-S CSI-RS generated based on the Type-S CSI-RS configuration information, from the BS via the transceiver. The at least one processor may be configured to determine channel state information (CSI) of a plurality of channels, based on the feedback configuration information and the Type-S CSI-RS, and transmit the determined CSI of the plurality of channels, to the BS via the transceiver.

A computer-readable recording medium disclosed as a technical means to achieve the aforementioned technical problems may have stored therein a program for executing, on a computer, at least one of embodiments of the disclosed method.

### DESCRIPTION OF DRAWINGS

FIG. 1 is a conceptual diagram of a multi-access supporting method using a switch network (SN), according to an embodiment of the present disclosure.

FIG. 2 is a diagram for describing a SN, according to an embodiment of the present disclosure.

FIG. 3 is a diagram for describing a SN, according to various embodiments of the present disclosure.

FIG. 4 is a flowchart of a multi-access supporting method using a SN, according to an embodiment of the present disclosure.

FIG. 5 is a diagram for describing an operation of identifying at least one subarray (SA) to be allocated to a plurality of user equipments (UEs), and determining structures of SNs respectively corresponding to the plurality of UEs, according to an embodiment of the present disclosure.

FIG. 6 is a diagram for describing an operation of identifying at least one SA to be allocated to a plurality of UEs, based on quality of services (QoSs) requested for the plurality of UEs, according to an embodiment of the present disclosure.

FIG. 7 is a graph showing a QoS of a UE which corresponds to each of structures of SNs, according to an embodiment of the present disclosure.

FIG. 8 is a graph for describing a QoS of a UE and base station power consumption (BS PC), based on a structure of a SN and the number of SAs allocated to a UE corresponding thereto, according to an embodiment of the present disclosure.

FIG. 9 is a graph showing PC of a BS using a structure of a SN, according to an embodiment of the present disclosure.

FIG. 10 is a diagram schematically illustrating a multi-access supporting method using a SN, according to an embodiment of the present disclosure.

FIG. 11 is a diagram for describing a relation between an antenna port and a SA in a multi-access supporting method using a SN, according to an embodiment of the present disclosure.

FIG. 12 is a diagram for describing a channel estimation method for each antenna port in a multi-access supporting method using a SN, according to an embodiment of the present disclosure.

FIG. 13 is a diagram for describing a method of performing channel estimation by using a Type-S channel-state information reference signal (CSI-RS), in a multi-access supporting method using a SN of a doubly connected (DC) type, according to an embodiment of the present disclosure.

FIG. 14 is a diagram for describing a method of performing channel estimation by using a Type-S CSI-RS, in a multi-access supporting method using a SN of a randomly connected (RC) type, according to an embodiment of the present disclosure.

FIG. 15 is a diagram for describing a perform interval of a Phase 1 operation, in a multi-access supporting method using a SN, according to an embodiment of the present disclosure.

FIG. 16 is a flowchart for describing operations of a BS and a UE which perform a multi-access supporting method using a SN, according to an embodiment of the present disclosure.

FIG. 17 is a schematic block diagram illustrating a configuration of a BS according to an embodiment of the present disclosure.

FIG. 18 is a schematic block diagram illustrating a configuration of a UE according to an embodiment of the present disclosure.

### MODE FOR INVENTION

Hereinafter, embodiments of the present disclosure will now be described more fully with reference to the accompanying drawings.

In the descriptions of the present disclosure, certain detailed explanations of the related art which are well known in the art to which the present disclosure belongs and are not directly related to the present disclosure are omitted. By omitting unnecessary explanations, the essence of the present disclosure may not be obscured and may be explicitly conveyed. The terms used in the specification are defined in consideration of functions used in the present disclosure, and can be changed according to the intent or commonly used methods of users or operators. Accordingly, definitions of the terms are understood based on the entire description of the present specification.

For the same reason, some elements in the drawings are exaggerated, omitted, or schematically illustrated. Also, the size of each element does not entirely reflect the actual size. In the drawings, the same or corresponding elements are denoted by the same reference numerals.

Advantages and features of the disclosure and methods of accomplishing the same may be understood more readily by reference to the following detailed descriptions of embodiments and accompanying drawings of the present disclosure. The present disclosure may, however, be embodied in many different forms and should not be construed as being limited to the embodiments set forth herein. Rather, these embodiments are provided so that the disclosure will be thorough and complete and will fully convey the concept of the present disclosure to one of ordinary skill in the art, and the present disclosure will only be defined by the appended claims. Throughout the specification, like reference numerals denote like elements. In the descriptions of the present disclosure, detailed explanations of the related art are omitted when it is deemed that they may unnecessarily obscure the essence of the present disclosure. The terms used in the specification are defined in consideration of functions used in the present disclosure, and can be changed according to the intent or commonly used methods of users or operators. Accordingly, definitions of the terms are understood based on the entire description of the present specification.

Hereinafter, a base station (BS) is an entity that allocates resources to a user equipment (UE), and may be at least one of a gNode B, an eNode B, a Node B, (or an xNode B, where, x indicates an alphabet letter including g or e), a radio access unit, a BS controller, a satellite, an airborne entity, or a node on a network. A user equipment (UE) may include a mobile station (MS), a vehicle, a satellite, an airborne entity, a cellular phone, a smartphone, a computer, or a multimedia system enabled to perform a communication function. In the present disclosure, a downlink (DL) may be a wireless transmission path of a signal transmitted from a BS to a UE, and an uplink (UL) may be a wireless transmission path of a signal transmitted from a UE to a BS. In addition, there may be a sidelink (SL) indicating a wireless transmission path of a signal being transmitted from a UE to another UE.

Although long term evolution (LTE), LTE-Advanced (LTE-A), or 5th generation (5G) system is mentioned as an example in the following description, embodiments of the present disclosure may also be applied to other communication systems having similar technical backgrounds or channel types. For example, 5G-Advance or New Radio (NR)-Advance or 6th generation (6G) mobile communication technology, which is developed after a 5G mobile communication technology (or NR), may be included therein, and hereinafter, 5G may refer to a concept including LTE, LTE-A, and other similar communication services. The present disclosure is applicable to other communication systems through modification at the discretion of one of ordinary skill in the art without greatly departing from the scope of the present disclosure.

It will be understood that each block of flowchart illustrations, and combinations of blocks in the flowchart illustrations, may be implemented by computer program instructions. The computer program instructions may be provided to a processor of a general-purpose computer, special purpose computer, or other programmable data processing apparatus, such that the instructions, which are executed via the processor of the computer or other programmable data processing apparatus, generate means for performing functions specified in the flowchart block(s). The computer program instructions may also be stored in a computer-executable or computer-readable memory that may direct the computer or other programmable data processing apparatus to function in a particular manner, such that the instructions stored in the computer-executable or computer-readable memory may produce an article of manufacture including instruction means that perform the functions specified in the flowchart block(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

In addition, each block of the flowchart illustrations may represent a module, segment, or portion of code, which includes one or more executable instructions for performing specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The term “ . . . unit” as used in the present embodiment refers to a software or hardware component, such as field-programmable gate array (FPGA) or application-specific integrated circuit (ASIC), which performs certain tasks. However, the term “ . . . unit” does not mean to be limited to software or hardware. A “ . . . unit” may be configured to be in an addressable storage medium or configured to operate one or more processors. Thus, according to an embodiment, a “ . . . unit” may include, by way of example, components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in the elements and “ . . . units” may be combined into fewer elements and “ . . . units” or further separated into additional elements and “ . . . units”. Further, the elements and “ . . . units” may be implemented to operate one or more central processing units (CPUs) in a device or a secure multimedia card. Also, according to some embodiments, a “ . . . unit” may include one or more processors.

Hereinafter, terms indicating broadcasting information, terms indicating control information, terms related to communication coverage, terms indicating a state change (e.g., event), terms indicating network entities, terms indicating messages, terms indicating elements of an apparatus, or the like, as used in the following description, are exemplified for convenience of descriptions. Accordingly, the present disclosure is not limited to terms to be described below, and other terms indicating objects having equal technical meanings may be used.

Hereinafter, for convenience of descriptions, terms and names defined in the most recent LTE and new radio (NR) standards from among current communication standards, the LTE and NR standards being defined by the 3rd Generation Partnership Project Long Term Evolution (3GPP LTE) group, may be used. However, the present disclosure is not limited to these terms and names, and may be equally applied to communication systems conforming to other standards.

In order to satisfy an increasing demand for data amount of a UE, a next-generation wireless communication system considers use of a high-frequency band including sub-THz (0.1 THz to 1 THz) so as to use a band of several tens to several hundreds of GHz, in addition to a mmWave band including a 28-GHz band. A terahertz (THz) communication system uses a plurality of antenna elements and a radio frequency (RF) chain so as to reduce a pathloss of a signal. Accordingly, when a high frequency band such as sub-THz or the like is used, the number of antennal elements and RF chains which are operated by a BS significantly increases to overcome a high propagation loss and absorption loss. In proportion to the increase in the number of antennal elements, the number of power amplifiers (PAs) and phase shifters (PSs) which are requested by the BS also increases. The increase in the number of elements included in an inner structure of the BS causes a significant increase in BS power consumption (PC), and thus, there is a need to reduce the BS PC. For example, the BS PC may be expressed by using Equation 1 below.

$$PC = {P}_{BB} + {N}_{RF} \cdot {P}_{RF} + {N}_{PA} \cdot {P}_{PA} + {N}_{PS} \cdot {P}_{PS} \qquad [ Equation 1 ]$$

In Equation 1, P_{BB} indicates a baseband (BB) power consumption, N_{RF} indicates the number of RF chains, P_{RF} indicates power consumption of a single RF chain, N_{PA} indicates the number of PAs, P_{PA} indicates power consumption of a single PA, N_{PS} indicates the number of PSs, and P_{PS} indicates power consumption of a single PS. According to Equation 1, as the number of RFs, PAs, and PSs included in the inner structure of the BS increases, the BS PC may increase.

Table 1 below indicates, in an embodiment, representative elements included in the inner structure of the BS, and PC of the elements. According to Table 1, Nₜ indicates the number of antenna subarrays (SAs), and N_{RF} indicates the number of RF chains of the BS. For example, in the inner structure of the BS, a connection between an RF chain and an antenna SA may have an array-of-subarray (AoSA) structure or a fully connected (FC) structure. Here, as a requested number of PSs varies depending on a connection structure between the RF chain and the antenna SA, in Table 1 below, a total amount of power consumed in a plurality of PSs in a BS is shown with respect to each of the AoSA structure and the FC structure.

TABLE 1

| | Power | Phase | | RF | |
|---|---|---|---|---|---|
| | amplifier | shifter | | chain | Baseband |
| Device | 60 | 42 | | 136 | 200 |
| power | | | | | |
| [mW] | | | | | |
| | | AoSA | FC | | |
| Power | 60 · Nₜ | 42 · Nₜ | 42 · Nₜ · N_{RF} | 136 · N_{RF} | 200 |
| consumption | | | | | |
| [mW] | | | | | |

Accordingly, in the embodiment of Table 1, the BS PC may be expressed by using Equation 2 and Equation 3 below, depending on the connection structure between the RF chain and the antenna SA in the inner structure of the BS. In Equation 2, PC_{AoSA} indicates the BS PC with respect to the BS having the AoSA structure, and in Equation 3, PC_{FC} indicates the BS PC with respect to the BS having the FC structure.

$${PC}_{AoSA} = 200 + 136 \cdot {N}_{RF} + 60 \cdot {N}_{t} + 42 \cdot {N}_{t} \qquad [ Equation 2 ]$$

$${PC}_{FC} = 200 + 136 \cdot {N}_{RF} + 60 \cdot {N}_{t} + 42 \cdot {N}_{t} \cdot {N}_{RF} \qquad [ Equation 3 ]$$

Referring to Equation 2 and Equation 3, the BS PC may be adjusted according to the number of RF chains (N_{RF}) and the number of antenna SAs (Nₜ). Therefore, in order to decrease the BS PC, there is a need to decrease the number of RF chains (N_{RF}) and the number of antenna SAs (Ni). In the THz communication system, there is a limit in decreasing the number of RF chains (N_{RF}) and the number of antenna SAs (Ni), due to a pathloss of a signal. Accordingly, by arraigning a switch network (SN) between an RF chain and a SA and changing a structure of the SN, the BS PC may be further optimized.

A wireless communication system using the SN may dynamically adjust a connection structure between the RF chain and the SA due to opening and closing of an independent switch (SW). The SN may refer to a network configured of switches between all RF chains and SAs. All connection structures between RF chains and SAs in an inner structure of a BS may be dynamically adjusted by the SN, according to a channel state at a time corresponding thereto. In the wireless communication system using the SN, the BS PC may be expressed by using Equation 4 below.

$$PC = {P}_{BB} + {N}_{RF} \cdot {P}_{RF} + {N}_{PA} \cdot {P}_{PA} + {N}_{PS} + {N}_{SW} \cdot {P}_{SW} \qquad [ Equation 4 ]$$

In Equation 4, P_{BB} indicates a BB power consumption, N_{RF} indicates the number of RF chains, P_{RF} indicates power consumption of a single RF chain, N_{PA} indicates the number of PAs, P_{PA} indicates power consumption of a single PA, N_{PS} indicates the number of PSs, P_{PS} indicates power consumption of a single PS, N_{SW} indicates the number of switches included in the SN, and P_{SW} indicates power consumption of a single switch. N_{RF} and N_{PA} may be adjusted based on the number of allocated SAs. N_{PS} and N_{SW} may be adjusted based on a structure of the SN. In the wireless communication system using the SN, by using the SN, not only N_{SW} but also N_{PS} may be dynamically adjusted, and furthermore, the BS PC may be minimized.

An operation of minimizing the BS PC by using Equation 4 may be expressed by using Equation 5 below.

$${min}_{W , {P}_{A} , {P}_{D}} PC s . t . {R}_{i} \geq {R}_{i , th} , \vert {( {P}_{A} )}_{i , j} \vert = 1 , {( W )}_{i , j} ∈ \{ 0 , 1 \} , {{⋃}^{k}}_{i = 1} {S}_{i} ⊂ S \qquad [ Equation 5 ]$$

In Equation 5, W indicates a SN, and (W), indicates a switch configured to connect an ith subframe to a jth RF chain in the SN. Each of switches included in the SN W may be open ((W)_{i,j}=0) or close ((W)_{i,j}=1). S indicates a set of all SAs, and Sᵢ indicates an SA set allocated to an ith UE. The SA set Sᵢ allocated to the ith UE is a part set of the set of all SAs S. Rᵢ indicates a quality of service (QoS) of the ith UE. R_{i,th} indicates a QoS requested for the ith UE. PA indicates an analog precoder, and P_{D} indicates a digital precoder. According to Equation 5, under the condition in which a QoS (R_{i,th}) requested for each of multiple UEs is satisfied, the SN W is adjusted so that the BS PC may be minimized.

In an embodiment, the more the number of close switches in the SN increased, the higher the spectral efficiency (SE) performance may be obtained. In this case, as the number of requested PSs (N_{PS}) also increases, the BS PC may increase. Therefore, according to an embodiment of the present disclosure, the SN may be optimized according to a QoS of a supported UE and a current channel state, based on a trade-off relation between the SE and the PC.

An operation of optimizing the BS PC by optimizing the SN may indicate an operation of adjusting a balance between QoSs of multiple UEs and the BS PC which have a trade-off relation. For example, the BS may adjust the BS PC to be minimum, to the extent that the QoSs of multiple UEs are satisfied.

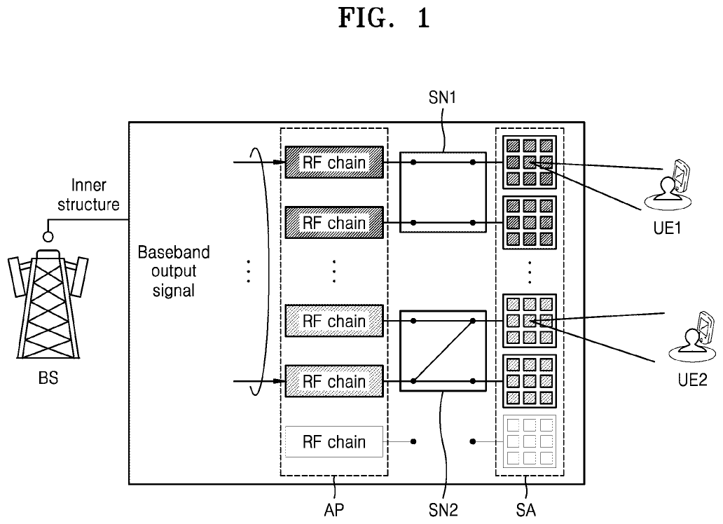

FIG. 1 is a conceptual diagram of a multi-access supporting method using a SN, according to an embodiment of the present disclosure.

Referring to FIG. 1, a method of supporting accesses of multiple UEs by using an SN-based BS structure is shown. According to an embodiment of the present disclosure, in a wireless communication system supporting accesses of multiple UEs, BS PC may be minimized while satisfying a QoS of each UE, by adjusting allocation of a SA and optimizing a SN structure. Also, according to an embodiment of the present disclosure, based on a Type-S channel-state information reference signal (CSI-RS) that is a new-structure RS, a UE may predict a channel state and provide a feedback of CSI.

Referring to FIG. 1, the wireless communication system that supports accesses of multiple UEs by using the SN may include a BS and a plurality of UEs whose accesses are supported by the BS. The BS may include a plurality of RF chains AP, a plurality of SNs SN1 and SN2, and a plurality of antenna SAs. The plurality of UEs may include a first UE UE1 and a second UE UE2.

In an embodiment, a SN may indicate a network that dynamically adjusts a connection structure between at least one RF chain AP and at least one SA by using a switch. For example, the SN may adjust a connection between a particular RF chain and a particular SA via opening or closing of a switch arranged between the particular RF chain and the particular SA, and as a result, due to such a switch, all connection structures between the RF chains AP and the SAs in the BS may be dynamically determined.

In an embodiment, the plurality of SNs may respectively correspond to the plurality of UEs. That is, the BS may determine a SN for each UE. For example, referring to FIG. 1, when the BS supports multiple accesses of two UEs, the first SN SN1 may correspond to the first UE UE1 from among supportable UEs, and the second SN SN2 may correspond to the second UE UE2 from among the supportable UEs. In this case, the first SN SN1 may include switches configured to connect SAs allocated to the first UE UE1 to RF chains allocated to the first UE UE1. Equally, the second SN SN2 may include switches configured to connect SAs allocated to the second UE UE2 to RF chains allocated to the second UE UE2.

In an embodiment, the more the number of closed switches in a SN increases, the higher the spectral efficiency (SE) performance may be obtained. In this case, as the number of requested PSs also increases, PC may increase. Therefore, according to an embodiment of the present disclosure, the SN may be optimized according to a QoS of a supported UE and a current channel state, based on a trade-off relation between the SE and the PC.

In order to support multiple UEs according to an embodiment of the present disclosure, the BS may independently allocate a currently-available SA to each UE, and may optimize a SN between the allocated SA and an RF chain. The number of SAs for supporting a particular UE and a structure of a SN corresponding to the particular UE may be determined based on a channel state of a time corresponding thereto and QoS information of the UE. Therefore, in order to allocate a SA and optimize a SN for each UE, a BS needs to obtain CSI information, QoS information, or the like of each UE. After the BS obtains the CSI information, the QoS information, or the like from each UE, the BS may determine the number of RF chains and the number of SAs to be allocated to UEs from among all available RF chains and SAs. Also, the BS may optimize each SN, based on the number of RF chains and the number of SAs which are allocated for each UE. In an embodiment, in order to minimize BS PC, a particular SA may not be allocated to any UE or a particular RF chain may not be used, according to channel state and QoS of UE.

A wireless communication system that supports multiple accesses by using a SN according to an embodiment of the present disclosure may minimize BS PC while satisfying QoSs of multiple UEs. To this end, the present disclosure describes a subarray allocation and switch network optimization algorithm (SSO algorithm) for adjusting allocation of a SA and optimizing a SN for each UE.

In this manner, referring to FIG. 1, the present disclosure may provide a wireless communication system using a SN, and may reduce BS PC while satisfying QoSs of multiple UEs.

In an ultra high-frequency wireless communication system involving mmWave and THz, a loss of signal may occur due to a SN being inserted between an RF chain and an antenna SA. Therefore, a technology for adjusting allocation of a SA and optimizing a SN for each UE according to the present disclosure may be operated exclusively from or mixedly with analog beamforming, according to a particular condition (a threshold value according to a frequency, etc.) A BS according to an embodiment may determine the number of SAs for supporting a UE and a structure of a SN corresponding to a particular UE for each frequency band. For example, the number of SAs determined for each UE and a structure of a SN corresponding to a particular UE may differ in each of below 6 Ghz, mmWave, and THz.

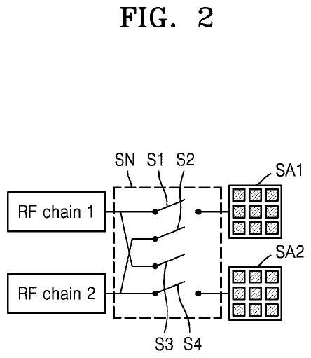

FIG. 2 is a diagram for describing a SN, according to an embodiment of the present disclosure.

A switch may correspond to a pair of one RF chain and one SA. When a SN is configured to connect n RF chains to m SAs, the SN may include n-m switches. For example, in a case where the SN is configured to connect two RF chains to two SAs, the SN may include 2−2=4 switches.

Referring to FIG. 2, in a case where two RF chains RF chain 1 and RF chain 2 are connected to two SAs SA1 and SA2, a SN may include a first switch S1, a second switch S2, a third switch S3, and a fourth switch S4. The first switch S1 may connect the first RF chain RF chain 1 to the first SA SA1. The second switch S2 may connect the second RF chain RF chain 2 to the first SA SA1. The third switch S3 may connect the first RF chain RF chain 1 to the second SA SA2. The fourth switch S4 may connect the second RF chain RF chain 2 to the second SA SA2.

The SN may adjust a connection between a particular RF chain and a particular subarray by controlling opening or closing of a switch arranged between the particular RF chain and the particular subarray.

In an embodiment, a wireless communication system using a SN of the present disclosure may control opening or closing of each of switches included in the SN, and may adjust a balance between QoSs of multiple UEs and BS PC which have a trade-off relation. For example, the BS may adjust the BS PC to be minimum, to the extent that the QoSs of multiple UEs are satisfied.

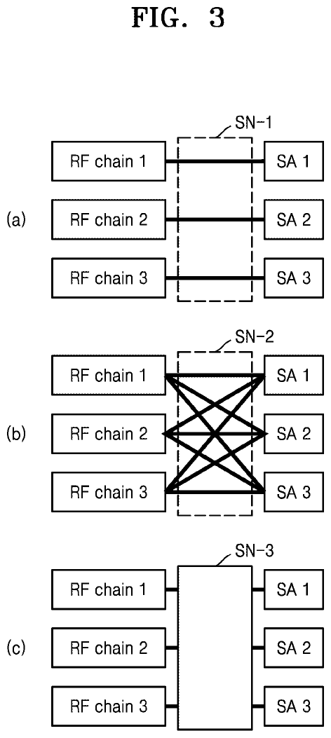

FIG. 3 is a diagram for describing a SN, according to various embodiments of the present disclosure.

Referring to FIG. 3, the SN may be configured to connect three RF chains RF chain 1, RF chain 2, and RF chain 3 to three SAs SA1, SA2, and SA3. In this case, the SN may include 3·3=9 switches. Each switch may correspond to a pair of one RF chain and one SA. In an embodiment, an ijth switch indicates a switch configured to connect an ith RF chain RF chain i to a jth SA SAj.

Referring to (a) of FIG. 3, a SN SN-1 may have an AoSA structure. The SN SN-1 having the AoSA structure connects a plurality of RF chains to a plurality of SAs in one-to-one manner. For example, in the ijth switch configured to connect the ith RF chain RF chain i to the jth SA SAj, when i and j are the same, the ijth switch is close, and when i and j are different, the ijth switch is open. Referring to (a) of FIG. 3, when a 11^{th} switch, a 22^{nd} switch, and a 33^{rd} switch are close, and a 12^{th} switch, a 13^{th} switch, a 21^{st} switch, a 23^{rd} switch, a 31^{st}, switch, and a 32^{nd} switch are open, the SN SN-1 has the AoSA structure.

Referring to (b) of FIG. 3, a SN SN-2 may have a FC structure. The SN SN-2 having the FC structure connects each of a plurality of RF chains to all SAs. For example, the ijth switch configured to connect the ith RF chain RF chain i to the jth SA SAj may have a structure in which the ijth switch is closed for all combinations of i and j. Referring to (b) of FIG. 3, when a total of nine ij switches (i=1, 2, 3 and j=1, 2, 3) connecting each of three RF chains RF chain 1, RF chain 2, and RF chain 3 to three SAs SA1, SA2, and SA3 are closed, the SN SN-2 has the FC structure.

In an embodiment, the SN SN-1 having the AoSA structure has a low degree of freedom in a configuration of an analog precoder, compared to the SN SN-2 having the FC structure. Therefore, compared to the SN SN-2 having the FC structure, the SN SN-1 having the AoSA structure has low spectral efficiency (SE) and has a high probability that a UE that does not satisfy a QoS may occur in multiple accesses of a plurality of UEs.

On the contrary thereto, compared to the SN SN-1 having the AoSA structure, the SN SN-2 having the FC structure has a high degree of freedom in a configuration of an analog precoder and has high spectral efficiency (SE). However, the SN SN-2 having the FC structure has an increased number of PSs, such that BS PC thereof is very high, compared to the SN SN-1 having the AoSA structure. Therefore, in order to adjust a balance between QoSs of multiple UEs and the BS PC which have a trade-off relation, a SN SN-3 having a randomly connected (RC) structure in which a more number of switches than those of the SN SN-1 having the AoSA structure are closed, and a fewer number of switches than those of the SN SN-2 having the FC structure are closed may be used.

Referring to (c) of FIG. 3, the SN SN-3 may have an RC structure. The SN SN-3 having the RC structure connects each of a plurality of RF chains to at least one SA.

For example, the RC structure may include a doubly connected (DC) structure. The DC structure indicates a structure in which one RF chain is connected to one SA, and RF chains other than the one RF chain are connected to two SAs. In the SN SN-3 having the DC structure, a first RF chain RF chain 1 may be connected only to a first SA SA1, and other RF chains, i.e., each of a second RF chain RF chain 2 and a third RF chain RF chain 3 may be connected to two SAs. For example, the second RF chain RF chain 2 may be connected to a first SA SA1 and a second SA SA2, and the third RF chain RF chain 3 may be connected to the second SA SA2 and a third SA SA3. However, a SN having the RC structure is not limited to the aforementioned DC structure, and may include various structures.

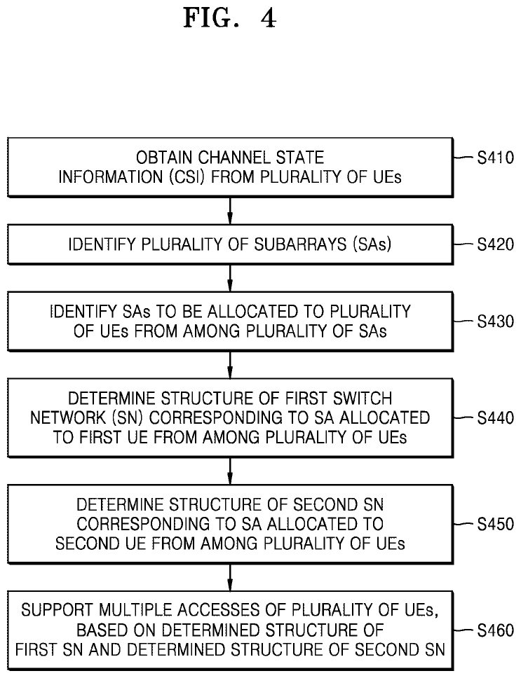

FIG. 4 is a flowchart of a method by which a BS supports multiple accesses of a plurality of UEs by using a SN, according to an embodiment of the present disclosure.

In operation S410, the BS obtains channel state information (CSI) from the plurality of UEs. In an embodiment, the BS may obtain the CSI from the plurality of UEs via a SN having an AoSA structure. Based on CSI for each antenna port obtained via the SN having the AoSA structure, the BS may allocate SAs to the plurality of UEs in operation S430 to be described below.

In operation S420, the BS identifies a plurality of SAs formed from an antenna array having a plurality of antenna elements. In an embodiment the antenna array may be a planar lattice array.

In operation S430, the BS identifies at least one SA to be allocated to the plurality of UEs from among a plurality of SAs. For example, the BS may identify to which UE each of the plurality of SAs is to be allocated. For example, the BS may identify a correspondence relation (allocation relation) between the plurality of SAs and the plurality of UEs.

In an embodiment, the BS may identify SAs to be allocated to the plurality of UEs, based on the CSI for each antenna port obtained in operation S410, a QoS condition requested for each of the plurality of UEs, and distance information (reference signal received power (RSRP), a time advance (TA), etc.) between the plurality of UEs and the BS. For example, in order to satisfy a QoS requested for a particular UE, the BS may determine how many SAs or how many RF chains are to be allocated to the corresponding UE.

In operation S440, the BS determines a structure of a first SN corresponding to at least one SA to be allocated to a first UE from among the plurality of UEs, and in operation S450, the BS determines a structure of a second SN corresponding to at least one SA to be allocated to a second UE from among the plurality of UEs.

In an embodiment, an nth SN may include at least one switch configured to connect at least one SA to at least one RF chain which are allocated to an nth UE. The BS may separately determine ON/OFF of the at least one switch included in the nth SN. The BS may determine structures of various SNs by separately adjusting opening or closing of a switch included in a SN.

In an embodiment, an operation in which the BS determines a structure of an nth SN corresponding to an nth UE may include an operation of determining the structure of the nth SN, based on BS PC. For example, the BS may determine structures of the nth SN so as to allow the BS PC to be minimum, to the extent that QoSs of all UEs for which multiple accesses are to be supported are satisfied.

In an embodiment, the BS may select one of preset structures of SNs to be the structure of the nth SN. Here, the preset structures of the SNs may be set based on whether channel estimation for a plurality of channels is available.

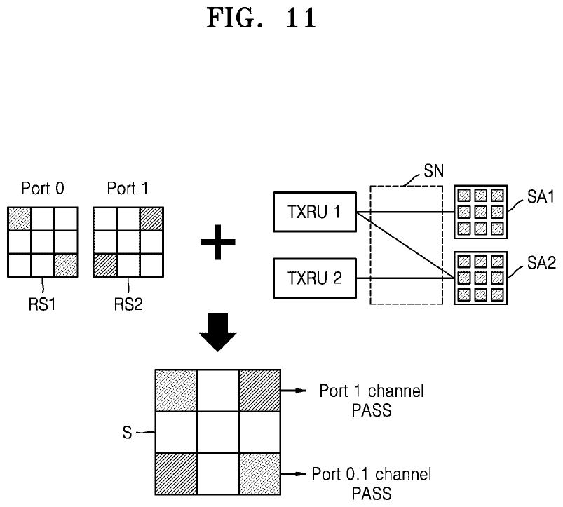

In a wireless communication system using a SN, a signal of a particular channel may be transmitted via two or more CSI-RS ports. In an embodiment, according to a structure of a SN, CSI obtainment from all channels may be available or CSI obtainment from some channels may not be available. In order to support multiple accesses for a plurality of UEs, CSI obtainment from all channels needs to be available. Therefore, in a multi-access supporting method using a SN according to the present disclosure, the BS uses only a SN having a structure in which CSI obtainment from all channels is available. A structure of a SN in which channel estimation of a plurality of channels is available will be further described below with reference to FIG. 11.

In operation S460, the BS supports multiple accesses of the plurality of UEs, based on the determined structure of the first SN and the determined structure of the second SN.

In an embodiment, the BS transmits Type-S CSI-RS configuration information to a UE corresponding thereto. The Type-S CSI-RS configuration information includes an index of CSI-RS configuration information, the number of antenna ports included in a CSI-RS, a transmission interval of the CSI-RS, transmission offset, resource configuration of the CSI-RS, CSI-RS scrambling ID, quasi co-location (QCL) information, or the like. In an embodiment, the UE may identify, based on the received Type-S CSI-RS configuration information, at least one of the number of ports for each CSI-RS, a timing in which each CSI-RS is to be transmitted, a resource location, and transmission power.

In an embodiment, the BS transmits, to the UE, feedback configuration information determined based on a structure of a SN corresponding to the UE. The feedback configuration information includes channel estimation priority information of a plurality of channels. As described above, in the wireless communication system using a SN, a signal of a particular channel may be transmitted via two or more CSI-RS ports. Therefore, in order to obtain CSI of all channels, an order of estimating CSI for each channel may be important. Accordingly, the BS may transmit, to the UE, the feedback configuration information including a priority order of estimating CSI for each channel, so as to enable CSI estimation of all channels. In an embodiment, the feedback configuration information may be included in the Type-S CSI-RS configuration information or may be provided by separate higher layer signaling or control signaling.

In an embodiment, the BS transmits a Type-S CSI-RS to the UE corresponding thereto, the Type-S CSI-RS being generated based on the Type-S CSI-RS configuration information. For example, the Type-S CSI-RS may be transmitted via at least one SA allocated to the corresponding UE. When the UE receives the Type-S CSI-RS, the UE estimates, by using the received Type-S CSI-RS, a channel between a transmission antenna of the BS and a reception antenna of the UE. Afterward, the UE may generate, based on the estimated channel, a rank indicator (RI), a precoding matrix index (PMI), or a channel quality indicator (CQI), which are feedback information, by using the received feedback configuration information and a predefined codebook. Afterward, the UE may transmit, to the BS, a plurality of pieces of feedback information (determined CSI) at feedback timing set according to the feedback configuration information.

The BS receives, from the UE, CSI determined based on the feedback configuration information and the Type-S CSI-RS. In an embodiment, in order to support an access of the UE, the BS may transmit a physical downlink shared channel (PDSCH) to the UE, according to the CSI determined based on the feedback configuration information and the Type-S CSI-RS. For example, according to the CSI determined based on the feedback configuration information and the Type-S CSI-RS, a modulation and coding scheme of the PDSCH may be determined.

In an embodiment, based on CSI received from the plurality of UEs, the BS may determine whether to additionally allocate a SA to at least one UE from among the plurality of UEs and whether to change a structure of a SN corresponding to the at least one UE. For example, in a case where there is a sharp change in channel states of UEs whose accesses are supported or a case where CSI to be considered is added as multiple new UEs request an access, the BS may adjust allocation of a SA or change structures of SNs for the plurality of UEs.

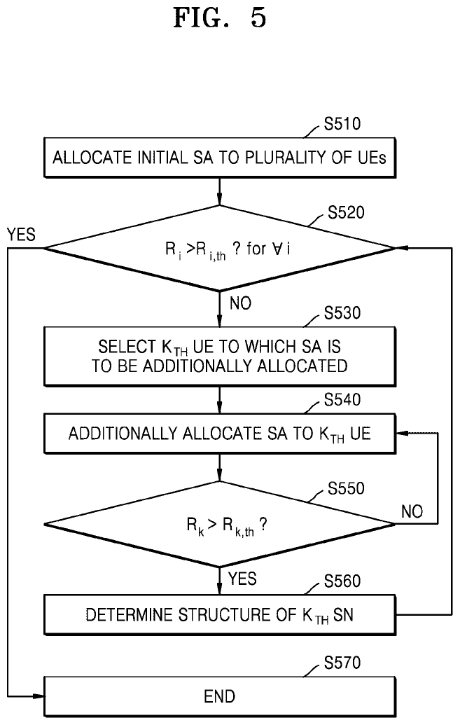

FIG. 5 is a diagram for describing an operation of identifying at least one SA to be allocated to a plurality of UEs, and determining structures of SNs respectively corresponding to the plurality of UEs, according to an embodiment of the present disclosure.

In operation S510, a BS allocates an initial SA to the plurality of UEs. In an embodiment, the BS may allocate a SA to the plurality of UEs, based on initial CSI for each antenna port, a QoS condition requested for each of the plurality of UEs, and distance information (RSRP, a TA, etc.) which are obtained from the plurality of UEs. Afterward, the BS may determine structures of SNs respectively corresponding to the plurality of UEs, and may control the SNs, based on the determined structures of the SNs.

In operation S520, the BS may determine whether a QoS of each UE satisfies a requested QoS. For example, whether a current QoS R exceeds a requested QoS Rum, may be determined with respect to all ith UEs.

In operation S530, the BS may select a kth UE to which a SA is to be additionally allocated, from among UEs of which QoSs do not satisfy the requested QoS.

In operation S540 and operation 8550, the BS may additionally allocate SAs to the kth UE until a QoS of the kth UE satisfies the requested QoS.

In operation S560, the BS may determine a structure of a kth SN corresponding to the kth UE that satisfies the requested QoS in a manner that at least one SA is additionally allocated thereto. In an embodiment, in the structure of the kth SN, ON/OFF of switches in the kth SN may be individually determined to minimize BS PC, to the extent that a QoS of the kth UE is satisfied.

In a case where the BS additionally allocates a SA to a plurality of UEs, for a UE, the BS may determine a structure of a SN corresponding to the UE whenever allocation of an additional SA is completed to satisfy a requested QoS, and after the BS completes allocation of an additional SA so as to satisfy a requested QoS for the plurality of UEs or all UEs, the BS may determine, at one time, structures of SNs corresponding thereto. That is, an operation of allocating an additional SA to a particular UE and an operation of determining a structure of a SN corresponding to other UE may be performed in various temporal orders.

Afterward, a method may be repeatedly performed until QoSs of all UEs satisfy a requested QoS.

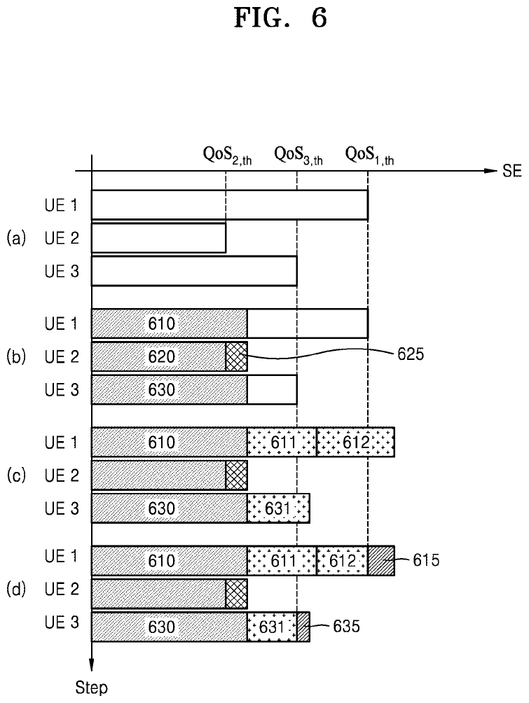

FIG. 6 is a diagram for describing an operation of identifying at least one SA to be allocated to a plurality of UEs, based on QoSs requested for the plurality of UEs, according to an embodiment of the present disclosure.

Referring to (a) of FIG. 6, a BS that supports multiple accesses to three UEs may identify a QoS requested for each of a first UE UE1, a second UE UE2, and a third UE UE3. In an embodiment, information about a QoS requested for each UE may be received from each corresponding UE.

Referring to (b) of FIG. 6, the BS allocates an initial SA to the first UE UE1, the second UE UE2, and the third UE UE3. For example, the BS may allocate a first initial SA 610 to the first UE UE1, allocate a second initial SA 620 to the second UE UE2, and allocate a third initial SA 630 to the third UE UE3.

In an embodiment, the BS may allocate an initial SA to a plurality of UEs, based on a QoS condition requested for each of the plurality of UEs or distance information (RSRP, a TA, etc.) between each of the plurality of UEs and the BS. For example, a SA to be initially allocated may be determined based on a UE of which requested QoS condition is the lowest. The UE of which requested QoS condition is the lowest may be a UE for which pathloss may be minimum as a distance between the BS and the UE is minimum from among the plurality of UEs. Referring to FIG. 6, in an embodiment, a UE of which requested QoS condition is the lowest may be the second UE UE2. Accordingly, the BS may allocate SAs to the first UE UE1, the second UE UE2, and the third UE UE3, the number of the SAs being equal to the number of SAs to satisfy QoS (QoS_{2,th}) requested for the second UE UE2.

Referring back to (b) of FIG. 6, afterward, the BS may control a second SN corresponding to the second UE UE2 that satisfies the requested QoS (QoS_{2,th}). For example, BS PC may be reduced by changing a structure of the second SN. In an embodiment, the change in the structure of the second SN may be performed to reduce the BS PC, with respect to a QoS part 625 exceeding the requested QoS (QoS_{2,th}) due to SA allocation.

In other word, initial SA allocation may refer to a procedure for allocating a same number of SAs to all UEs after a minimum number of SAs requested by a UE closest to a BS is obtained. This operation may be performed by using Equation 6 below. For example, assuming that a kth UE has a smallest distance to the BS, a QoS requested for the kth UE may be QOS_{k,th}, and a set of SAs allocated to the kth UE may be Sₖ.

$$\vert {S}_{k} {\vert}^{*} = {min}_{{S}_{k} ⊂ S} \vert {S}_{k} \vert s . t . {QoS}_{k , th} \leq {QoS}_{k} \qquad [ Equation 6 ]$$

Referring to Equation 6, when a set of all SAs is S, Sₖ that is the set of SAs allocated to the kth UE is a subset of S (Sₖ⊂S). A minimum number of SAs (|Sₖ|*) requested for the kth UE may be determined to be a minimum value from among the set of SAs Sₖ satisfying the QoS_{k,th}, requested for the kth UE.

A degree of QoS satisfaction for each UE according to the initial SA allocation may be determined, assuming that a structure of a SN corresponding to each UE is a FC structure. Referring to (b) of FIG. 6, a QoS may be satisfied only by allocating the initial SA, as in the second UE UE2. In this case, in order to minimize the BS PC, an optimization operation may be performed on a SN between a SA and an RF chain which are allocated to the corresponding UE. An optimization operation for a SN may refer to an operation of determining a structure of the SN so as to simultaneously satisfy a QoS of a UE and minimize BS PC. For example, after the BS calculates BS PC for each of opening/closing patterns of a plurality of preset SNs, the BS may determine opening or closing of a switch to connect a particular RF chain to a SA, based on an opening/closing pattern of a SN which causes the smallest PC. However, this is merely an example, and the BS may calculates PC for opening/closing structures of all switches available in an allocated structure of an SN, and may select an opening/closing structure of a switch which causes minimum PC.

Referring to (c) of FIG. 6, the BS may determine whether QoSs of all UEs satisfy a requested QoS. For example, whether a current QoS Rᵢ exceeds a requested QoS R_{i,th} may be determined with respect to all ith UEs. After the initial SA allocation, if there are UEs such as the first UE UE1 and the third UE UE3 of which QoSs do not satisfy, an additional SA may be allocated thereto. The BS may select the kth UE to which a SA is to be additionally allocated from among UEs not satisfying the requested QoS, and may additionally allocate a SA to the kth UE until a QoS of the kth UE satisfies the requested QoS.

An operation of additionally allocating a SA to at least one UE may indicate that, after a priority order by which a SA is additionally allocated to the at least one UE from among UEs not satisfying a QoS is set, a SA with the best channel state is allocated to the at least one UE, and optimization of a SN corresponding to the at least one UE is performed. First, SA additional allocation may be first performed on a UE (k*) for which a difference between QoS (QoSₖ) of the kth UE and the requested QoS (QoS_{k,th}) according to the initial SA allocation is minimum, by using Equation 7 below.

$${k}^{*} = {arg min}_{k} \vert {QoS}_{k , th} - Q o {S}_{k} \vert \qquad [ Equation 7 ]$$

Afterward, the current BS additionally allocates one SA to the k* UE, the one SA being from among SAs not allocated to other UEs. As the BS obtained channel information for each SA from all UEs, an index of a SA to be additionally allocated may correspond to an operation of identifying a SA with the best channel state, in terms of the k* UE. A reference for determining whether a channel state is excellent may vary, and for example, there may be a method such as Frobenius norm which uses Equation 8 below.

$${i}^{*} = {arg max}_{i ∈ {( ⋃ {S}_{i} )}^{C}} {‖ {H}_{i , {k}^{*}} ‖}_{F}^{2} \qquad [ Equation 8 ]$$

After a i* SA is additionally allocated to the k* UE, when it is determined that a QoS of the k* UE satisfies the requested QoS, the BS may perform a procedure for optimizing a k* SN so as to minimize PC. When the QoS is not satisfied, the BS may repeatedly perform an operation of additionally allocating a SA within the number of SAs which are usable by the BS, and by doing so, the BS may satisfy all QoSs of multi-access supported UEs.

Referring to (d) of FIG. 6, after the BS satisfies all QoSs of multi-access supported UEs, the BS may determine structures of a plurality of SNs respectively corresponding to a plurality of UEs. In an embodiment, in the structure of the kth SN, ON/OFF of switches in the kth SN may be individually determined to minimize BS PC, to the extent that a QoS of the kth UE is satisfied. In an embodiment, the change in the structure of the first SN may be performed to reduce the BS PC, with respect to a QoS part 615 of the first UE UE1 which exceeds the requested QoS (QoS_{1,th}). Also, the change in the structure of the third SN may be performed to reduce the BS PC, with respect to a QoS part 635 of the third UE UE3 which exceeds the requested QoS (QoS_{3,th}).

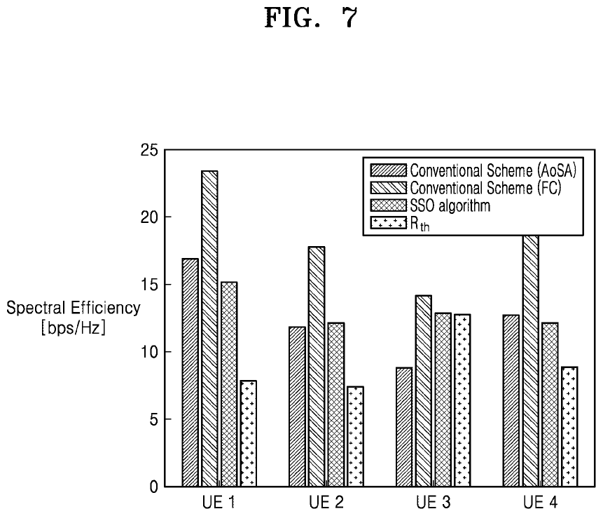

FIG. 7 is a graph showing a QoS of a UE which corresponds to each of structures of SNs, according to an embodiment of the present disclosure.

In the test example of FIG. 7, a QoS of each UE is set to a requested rate R, and system parameters are shown in Table 2 below. In Table 2, UE refers to a terminal, and U (a, b) refers to continuous uniform distribution between a and b.

TABLE 2

| Carrier frequency | 0.3 | THz |
|---|---|---|
| Transmit power | 20 | dBm |
| Total # SA | 16 | |
| # antennas in each SA | 64 | |
| UE distance | U(5, 10) | m |
| UE QoS threshold | U(7, 13) | bps/Hz |

FIG. 7 shows the test results of a case in which the SSO algorithm according to an embodiment of the present disclosure is applied to four UEs. FIG. 7 shows, after a SA is allocated to each UE, whether each UE satisfies a requested rate when optimization of an SN is performed. In the test example of FIG. 7, the BS allocated a same number of available SAs to each of the UEs, and a structure of a SN is set to an AoSA structure, a FC structure, and an RC structure based on the SSO algorithm.

Referring to FIG. 7, all UEs other than the third UE UE3 can satisfy the requested rate in the SN having the AoSA structure, the FC structure, and the RC structure based on the SSO algorithm, but the third UE UE3 cannot satisfy the requested rate in the SN having the AoSA structure but can satisfy the requested rate in the SN having the RC structure based on the SSO algorithm or the FC structure.

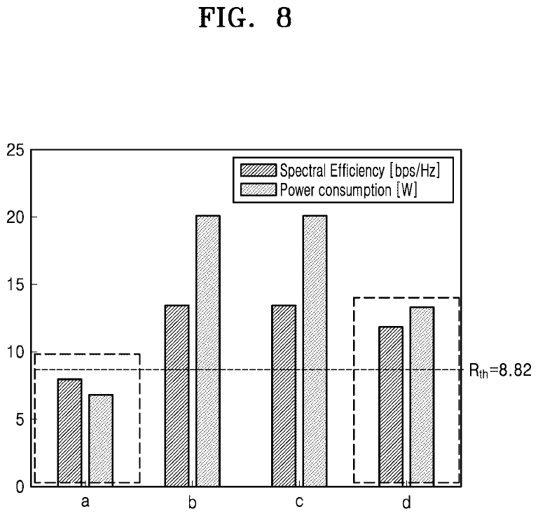

FIG. 8 is a graph for describing a QoS of a UE and BS PC, based on a structure of a SN and the number of SAs allocated to a UE corresponding thereto, according to an embodiment of the present disclosure.

FIG. 8 illustrates an example for verifying whether the SSO algorithm according to an embodiment of the present disclosure is appropriate in terms of the number of allocated SAs and minimization of PC for a fourth UE UE4 of FIG. 7. In the example of FIG. 8, a requested rate and PC was compared while the number of SAs allocated to the fourth UE UE4 was varied based on the number of SAs determined by using the SSO algorithm. In FIG. 8, the embodiment d corresponds to the comparative embodiment.

In the embodiment a, one of SAs allocated via the SSO algorithm in the embodiment d was randomly removed, and a structure of a SN was changed to an FC structure. When the number of allocated SAs is fixed, an SE of a case where the SN has the FC structure is a maximum value of the SE that can be achieved. Therefore, according to the embodiment a, it is possible to identify whether the number of SAs allocated to a UE in the embodiment d is minimum, to the extent that a rate of the UE is satisfied.

In the embodiment b, one SA was randomly allocated to SAs allocated via the SSO algorithm in the embodiment d, and a structure of a SN was changed to an AoSA structure. When the number of allocated SAs is fixed, an SE of a case where the SN has the AoSA structure is a minimum value of the SE that can be achieved. Therefore, according to the embodiment b, it is possible to identify that BS PC increases in a case where a SA is additionally allocated to satisfy a rate of a particular rate.

In the embodiment c, one SA was randomly applied to SAs allocated based on the SSO algorithm in the embodiment d, and a structure of a SN was adjusted based on the SSO algorithm, in consideration of the added SA. Comparing the embodiment c with the embodiment d, when a more number of SAs than a minimum number of SAs for satisfying the rate of the UE were allocated, even when the structure of the SN was optimized, BS PC increases due to the additionally allocated SA.

The embodiment a could not satisfy the rate requested by the UE, and the embodiments b and c satisfied the rate requested by the UE but had high PC, compared to the comparative embodiment d in which SA allocation determined based on the SSO algorithm and a SN were maintained. Therefore, referring to FIG. 8, it is possible to identify that the SSO algorithm can adjust an optimal balance, in terms of satisfaction of the requested rate and minimization of PC.

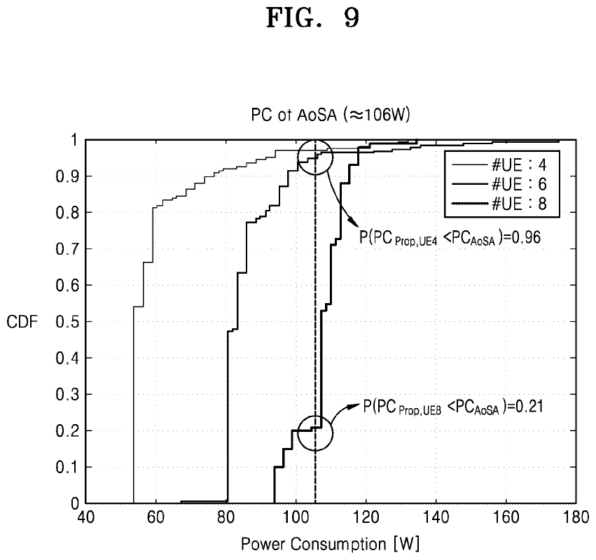

FIG. 9 is a graph showing PC of a BS using a structure of a SN, according to an embodiment of the present disclosure.

FIG. 9 shows average PC of the BS for supporting four, six, or eight UEs. It is assumed that a SN having an AoSA structure set for comparison uses all SAs and RF chains included in the BS, and has PC of about 106 Watt. When the number of multi-access supported UEs is 4 or 6, a probability that PC of a scheme of supporting multiple accesses of UEs via the SSO algorithm according to an embodiment of the present disclosure is lower than the comparison is about 96%, whereas, when the number of UEs is increased to 8, the probability is sharply decreased to about 21%. This may be because the more the number of UEs is increased, the more the number of SAs that can be allocated to each UE is increased, such that the number of closed switches in a structure of a SN is increased. However, a SN having an AoSA structure may not satisfy an amount of rate requirement with respect to some UEs, as shown in FIG. 7. Therefore, the SSO algorithm according to an embodiment of the present disclosure has an effect of reducing BS PC, to the extent that an amount of rate requirement of all UEs still can be satisfied.

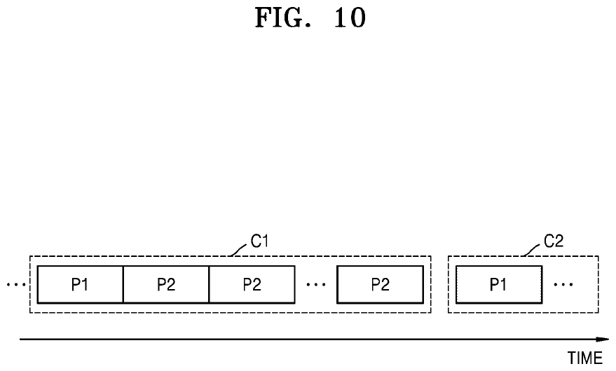

FIG. 10 is a diagram schematically illustrating a multi-access supporting method using a SN, according to an embodiment of the present disclosure.

Referring to FIG. 10, a SN-based communication system may separately perform Phase 1(P1) and Phase 2(P2). In an embodiment, a cycle 1 C1 may indicate an operation of sequentially performing one Phase 1 and then Phase 2 until next Phase 1 is performed.

‘Phase 1’ indicates an operation of obtaining information of UEs for performing the SSO algorithm, and performing the SSO algorithm by using the information before multi-access support using a SN is performed. In order to obtain, from a plurality of UEs, a requested rate and CSI for each channel, the BS may configure a structure or the SN to be an AoSA structure. Afterward, the BS may identify a SA to be allocated to each UE, by performing the SSO algorithm by using the obtained CSI for each channel, and may determine a structure of a SN corresponding to each of the UEs.

‘Phase 2’ indicates an operation in which multiple accesses of the plurality of UEs are supported by using SA allocation and SN structure for each UE which are determined via Phase 1. When Phase 2 is preformed, the BS uses a structure of a SN which is determined according to the SSO algorithm, and thus, may have a RC structure, not the AoSA structure in which an RF chain and a SA are connected by 1:1.

In an embodiment, in Phase 2, in a case where it is determined that there is a sharp change in a channel state, based on CSI received from a UE, or where CSI to be considered is added due to an access request by a plurality of new UEs, the BS may adjust SA allocation to the plurality of UEs or may perform Phase 1 so as to change a structure of a SN. New Phase 1, and at least one Phase 2 in which multiple accesses of a plurality of UEs are supported by using SA allocation to each UE and a structure of a SN, which are adjusted via Phase 1, may configure a cycle 2 C2.

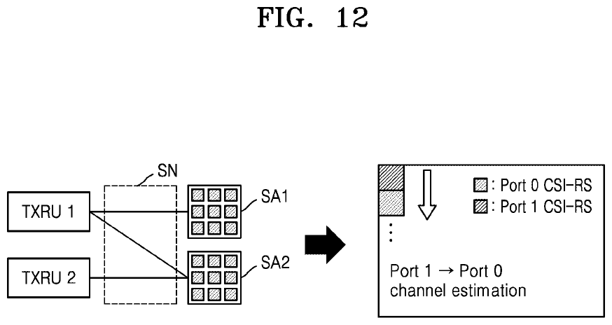

FIG. 11 and FIG. 12 are diagrams for describing a channel estimation method for each antenna port in a multi-access supporting method using a SN, according to an embodiment of the present disclosure.

Rel.13 LTE supports up to 16 CSI-RS antenna ports for allowing a plurality of antenna elements (e.g., 64 or 128) to be mounted in a gNB. In this case, a plurality of antenna elements are mapped to one CSI-RS port. Also, in Rel.14 LTE, up to 32 CSI-RS ports are supported. In a case of a next-generation cellular system such as 5G, it is expected that a maximum number of CSI-RS ports is maintained in an almost same level.

In the mmWave band, the number of antenna elements for a given form factor may be greater, but the number of CSI-RS ports that may correspond to the number of digitally-precoded ports may be limited due to hardware constraints. For example, such a transmitter may be provided to the BS or the UEs of FIG. 1.

Referring to FIG. 11, one CSI-RS port may be mapped to a plurality of antenna elements which are controllable by a bank of an analog phase shifter. Afterward, one CSI-RS port may correspond to one SA that generates a narrow analog beam via analog beamforming. An analog beam may be configured to perform sweeping over a broader range of angles by converting a phase shifter bank over a symbol or a subframe or a slot (the subframe or the slot may include collection of symbols or include a transmission time interval). The number of SAs which is equal to the number of RF chains is equal to the number of CSI-RS ports N_{CSI-port}. A digital beamforming unit may further increase a precoding gain by performing linear combination over N_{CSI-port} analog beams. An analog beam may be applied to a broad band, and digital precoding may be determined a unit of frequency sub-band or resource block. A receiver may receive each of beams transmitted via the analog beamforming or the digital beamforming.

Referring to FIG. 11, a different CSI-RS may correspond to each antenna port. For example, a first antenna port Port 0 may correspond to a first CSI-RS RS0, and a second antenna port Port 1 may correspond to a second CSI-RS RS1.

Also, referring to FIG. 11, as the BS uses a structure of a SN determined according to the SSO algorithm, the BS has a RC structure, not an AoSA structure in which an RF chain (or a transceiver unit (TXRU)) and a SA are connected by 1:1. For example, in an embodiment in which two TXRUs and two SAs are included, a first TXRU may be connected to a first SA, the first TXRU may be connected to a second SA, and a second TXRU may be connected to the second SA.

In this manner, in a wireless communication system using a SN having an RC structure, a signal of a particular channel may be transmitted via two or more CSI-RS ports. For example, referring to FIG. 11, a signal of a first channel which corresponds to a first SA1 is received only via Port 0, but a signal of a second channel which corresponds to a second SA SA2 may be transmitted via Port 0 and Port 1. Therefore, when a legacy CSI-RS is used, a UE in the SN having the RC structure cannot perform channel estimation for each antenna port. Therefore, for channel estimation by the UE in the SN having the RC structure uses ‘Type-S CSI-RS’.

Referring to FIG. 12, a channel estimation priority order for each of ports Port 0 and Port 1 according to a structure of a SN has to be determined. Therefore, channel estimation of other port (Port 0) may be possible only when channel information of a particular port (Port 1) is used in a channel estimation procedure for the other port (Port 0). The UE performs a CSI feedback operation while performing channel estimation according to a channel estimation order (Port 1->Port 0) for each port (Port 0, Port 1), the order being pre-defined with the BS. The channel estimation order for each port may be predefined between the BS and the UE via a Type-S CSI-RS. The channel estimation order for each port may be transmitted from the BS to the UE via feedback configuration information.

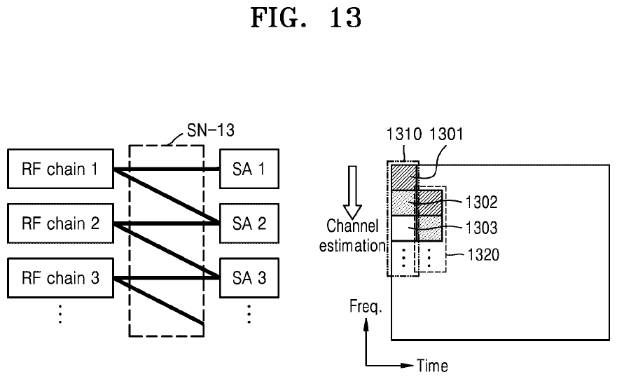

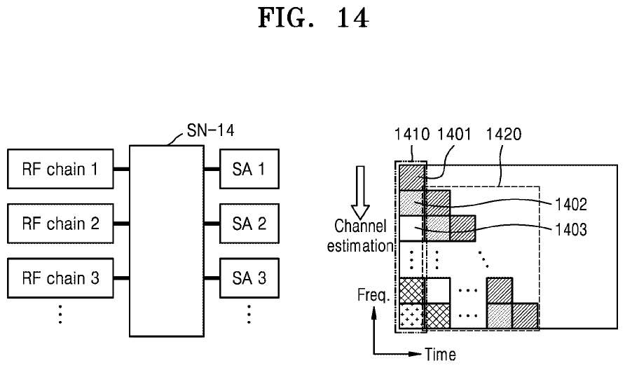

In this manner, a Type-S CSI-RS is characterized in that it uses an estimation result of a particular port in channel estimation of another port, based on a channel estimation order for each port being determined according to a structure of a SN. Type-S CSI-RS configuration according to an exemplary structure of a SN will be described in detail below with reference to FIG. 13 and FIG. 14.

FIG. 13 is a diagram for describing a method of performing channel estimation by using a Type-S CSI-RS, in a multi-access supporting method using a SN of a DC type, according to an embodiment of the present disclosure.

FIG. 13 illustrates Type-S CSI-RS configuration for use in a DC-SN structure. The DC-SN structure indicates a structure of a SN SN-13 in which one TXRU is connected to one SA and TXRUs other than the one TXRU are connected to each of two SAs. A Type-S CSI-RS that is allocated to a first orthogonal frequency division multiplexing (OFDM) symbol defined in a resource block (RB) indicates a CSI-RS at each antenna port, and a Type-S CSI-RS allocated to a second OFDM symbol indicates a channel interference in other antenna ports which affects a Type-S CSI-RS of a previous OFDM symbol of the same frequency.

A UE may perform channel estimation for each antenna port via the Type-S CSI-RS configuration of FIG. 13 in a procedure below. First, the UE performs channel estimation of a first antenna port by using a Type-S CSI-RS received via a first subcarrier 1301 that is a subcarrier of a highest frequency in a Type-S CSI-RS allocated to a first OFDM symbol. This is channel estimation corresponding to a first RF chain RF Chain 1 in an embodiment of the DC-SN structure. Afterward, the UE performs channel estimation of a next antenna port via a similar scheme to successive interference cancellation (SIC) by using channel information of an antenna port on which channel estimation is already performed. For example, the UE may perform channel estimation of a second RF chain RF Chain 2 corresponding to a Type-S CSI-RS received via a second subcarrier 1302, by using a result of the channel estimation of the first RF chain RF Chain 1.

Afterward, the UE may perform channel estimation of a third RF chain RF Chain 3 corresponding to a Type-S CSI-RS received via a third subcarrier 1303, by using a result of the channel estimation of the second RF chain RF Chain 2.

The channel estimation for each antenna port may be performed in order starting from a Type-S CSI-RS allocated to a subcarrier corresponding to a highest frequency in a Type-S CSI-RS allocated to a first OFDM symbol toward a Type-S CSI-RS allocated to a subcarrier corresponding to a lowest subcarrier. By repeating the procedure, the UE may perform channel estimation for each antenna port in the DC-SN structure.

After a DC-SN structure applicable to each used antenna port is pre-defined, a Type-S CSI-RS may be dynamically changed and used according to a structure of a corresponding SN. A CSI-RS overhead of a legacy CSI-RS is N, assuming that a CSI-RS density is 1, whereas a CSI-RS overhead of a Type-S CSI-RS according to an embodiment of the present disclosure is 2N-1.

In an embodiment, a Type-S CSI-RS is not always allocated to a neighboring subcarriers, and the Type-S CSI-RS may be received via subcarriers of various preset locations.

FIG. 14 is a diagram for describing a method of performing channel estimation by using a Type-S CSI-RS, in a multi-access supporting method using a SN of an RC type, according to an embodiment of the present disclosure.

FIG. 14 illustrates Type-S CSI-RS configuration for use in various RC-SN structures. An RC-SN structure indicates a structure in which channel estimation of all channels is available via Type-S CSI-RS configuration, from among structures of a SN SN-14 via which a plurality of TXRUs and a plurality of SAs are randomly connected.

Whether channel estimation with respect to all channels is available depends on a structure of a SN. For example, in a FC structure, as channels of all antenna ports are received via a particular subcarrier, CSI estimation for each channel is not available. A structure of a SN according to an embodiment of the present disclosure may be determined in such a manner that channel estimation can be performed on all antenna ports. The DC-SN structure of FIG. 13 is an example of the RC-SN structure in which channel estimation with respect to all antenna ports is available.

In the SN SN-14 of the RC-SN structure, channel estimation may be performed based on SIC, as in the DC-SN structure. For example, with respect to a Type-S CSI-RS allocated to a first OFDM symbol defined in a RB, channel estimation for each antenna port may be performed starting from a CSI-RS of an antenna port allocated to a subcarrier of a high frequency. From a second OFDM symbol, a channel interference in other antenna ports which affects a CSI-RS of a particular antenna port may be removed via a SIC scheme or the like by using an allocated Type-S CSI-RS. In an embodiment, a channel estimation priority order for antenna port may be determined based on symbol information about all time slots.

Referring to FIG. 14, the UE may perform channel estimation of a first antenna port by using a Type-S CSI-RS received via a first subcarrier 1401. This may be expressed as channel estimation corresponding to a first RF chain RF Chain 1 in an embodiment of the RC-SN structure. Afterward, the UE may perform channel estimation of a next antenna port via a SIC scheme by using channel information of an antenna port on which channel estimation is already performed. For example, the UE may perform channel estimation of a second RF chain RF Chain 2 corresponding to a Type-S CSI-RS received via a second subcarrier 1402, by using a result of the channel estimation of the first RF chain RF Chain 1.

Afterward, the UE may perform channel estimation of a third RF chain RF Chain 3 corresponding to a Type-S CSI-RS received via a third subcarrier 1403, by using results of the channel estimation of the first RF chain RF Chain 1 and the channel estimation of the second RF chain RF Chain 2.

After a RC-SN structure applicable to each used antenna port is pre-defined, a Type-S CSI-RS may be dynamically changed and used according to a structure of a corresponding SN. A Type-S CSI-RS used in the RC-SN structure in which the number of closed switches in the SN SN-14 is greater than that of the DC-SN, has a high CSI-RS overhead, compared to a Type-S CSI-RS used in the DC-SN. A CSI-RS overhead of a Type-S CSI-RS may be dynamically changed according to a RC-SN structure for use, and may be up to N(N−1)/2. A Type-S CSI-RS may have a greater overhead than a normal CSI-RS, however, when the Type-S CSI-RS is used, channel estimation of all channels is possible in a wireless communication system using a SN for reducing BS PC.

In the RC-SN structure, a Type-S CSI-RS is not always allocated to a neighboring subcarrier, and thus, the Type-S CSI-RS may be received via subcarriers of various preset locations.

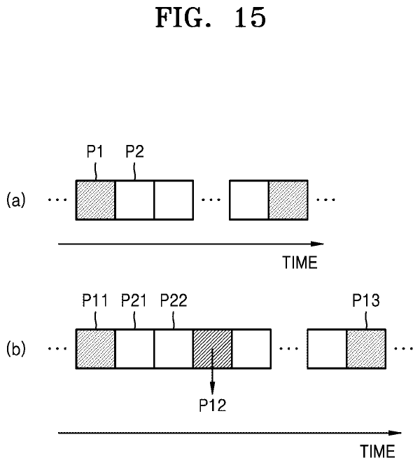

FIG. 15 is a diagram for describing a perform interval of a Phase 1 operation of performing the SSO algorithm, in a multi-access supporting method using a SN, according to an embodiment of the present disclosure.

As described above, the SN-based communication system may separately perform Phase 1(P1) and Phase 2(P2). Phase 1(P1) indicates an operation of obtaining information of UEs for performing the SSO algorithm, and performing the SSO algorithm by using the information before multi-access support using a SN is performed. Phase 2(P2) indicates an operation in which multiple accesses of the plurality of UEs are supported by using allocation of a SA for each UE and a structure of the SN which are determined via the most recent previous Phase 1(P1).

Referring to (a) of FIG. 15, Phase 1(P1) may be regularly performed at preset time intervals. In a case where SA allocation and SN network structure which are determined in Phase 1(P1) can be still used to perform Phase 2(P2) as a channel change in supported UEs is small, Phase 1(P1) may be periodically performed. Also, when the number of UEs that newly request an access is small, Phase 1(P1) may be periodically performed.

Referring to (b) of FIG. 15, additional Phase 1(P12) may be additionally performed to adjust SA allocation or change a SN structure for a plurality of UEs, between Phases 1 P11 and P13 which are performed at preset time intervals. The additional Phase 1(P12) may be performed in a case where it is determined that there is a sharp change in a channel state, based on CSI received from the UE, or where CSI to be considered is added due to an access request by a plurality of new UEs.

In an embodiment, the additional Phase 1(P12) may not have an effect on perform timings of Phases 1 P11 and P13 which are performed at preset time intervals. That is, when a preset Phase 1 perform interval is L, time intervals of P11 and P13 may be maintained as L, P13 may be performed at an estimated timing, regardless of a perform timing of P12.

In another embodiment, the additional Phase 1(P12) may have an effect on perform timing of Phase 1 P13 which is to be performed thereafter. For example, after the additional Phase 1(P12) is performed, Phase 1 may be periodically performed, based on Phase 1(P12) being most-recently performed. Here, when the preset Phase 1 perform interval is L, P13 may be performed at a timing after one interval from P12 that is Phase 1 being most-recently performed.

Phases 2 P21 and P22 may be sequentially performed between Phases 1 which are neighboring on a timeline. Phase 2 may support multiple accesses of a plurality of UEs by using SA allocation and SN structure for each UE which are determined in the most recent previous Phase 1.

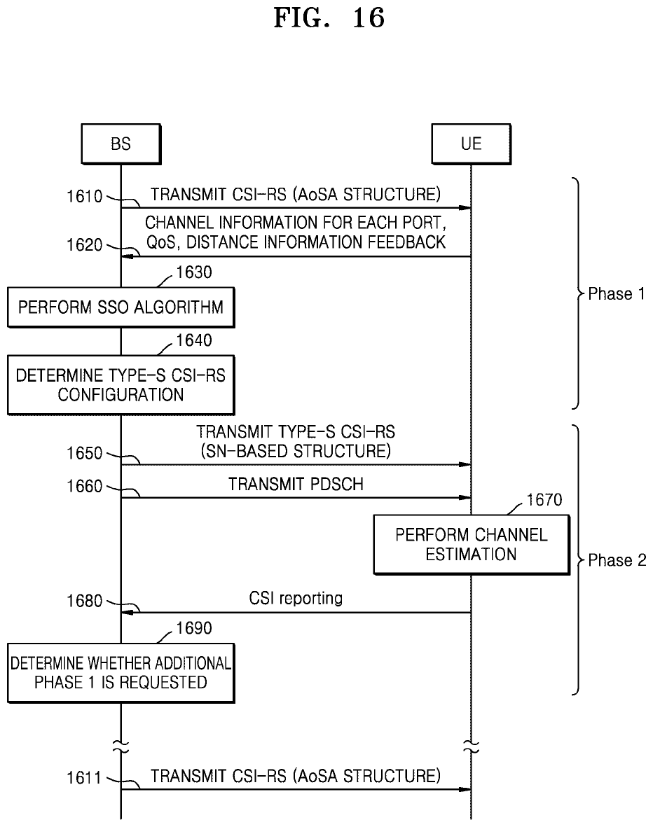

FIG. 16 is a flowchart for describing operations of a BS and a UE which perform a multi-access supporting method using a SN, according to an embodiment of the present disclosure.

Referring to FIG. 16, the BS performs Phase 1 before Phase 2 that supports wireless communication of multiple UEs is performed. In performing Phase 1, a SN of the BS has an AoSA structure, and in performing Phase 2, the SN of the BS has a SN structure determined in Phase 1 that is the most-recent previous one on a timeline.

Phase 1 may be performed via operation S1610 to operation S1640. In Phase 1, the BS may determine SA allocation and SN structure for each UE, and may determine Type-S CSI-RS configuration, based on the determined SN structure.

In operation S1610, the BS transmits a CSI-RS to each of a plurality of UEs.

In operation S1620, the BS obtains, from the plurality of UEs, channel information for each port which is determined based on the CSI-RS. Also, the BS may additionally receive, from the plurality of UEs, a QoS condition requested for each UE, and distance information (RSRP, a TA, etc.) between the plurality of UEs and the BS. QoS information of a UE includes information about all communication quality requirements including a rate requested by the UE. Operation S1620 may be performed in a similar manner to operation S410 of FIG. 4.

In operation S1630, the BS performs an SSO algorithm of adjusting SA allocation and optimizing a SN for each UE.

First, the BS identifies at least one SA to be allocated to the plurality of UEs, from among a plurality of SAs. For example, the BS may identify to which UE each of the plurality of SAs is to be allocated. The BS may identify SAs to be allocated to the plurality of UEs, based on CSI for each antenna port, the QoS condition requested for each of the plurality of UEs, and the distance information between the plurality of UEs and the BS, which are obtained in operation S1620. For example, in order to satisfy a QoS requested for a particular UE, the BS may determine how many SAs or how many RF chains are to be allocated to the corresponding UE.

Afterward, the BS determines structures of SNs which respectively correspond to the plurality of UEs. An nth SN allocated to an nth UE may include at least one switch to connect at least one SA to at least one RF chain which are allocated to the nth UE. The BS may separately determine ON/OFF of the at least one switch included in the nth SN. The BS may variously determine a structure of a SN by separately adjusting opening or closing of a switch included in the SN. The BS may determine a structure of a SN, based on BS PC. For example, the BS may determine the structure of the SN so as to allow the BS PC to be minimum, to the extent that QoSs of all UEs are satisfied. Operation S1630 may be performed in a similar manner to operations S430, S440, and S450 of FIG. 4.

In operation S1640, the BS determines Type-S CSI-RS configuration, based on the structure of the SN determined in operation S1630. A Type-S CSI-RS may be determined based on Type-S CSI-RS configuration information and feedback configuration information. The Type-S CSI-RS configuration information includes an index of CSI-RS configuration information, the number of antenna ports included in a CSI-RS, a transmission interval of the CSI-RS, transmission offset, resource configuration of the CSI-RS, CSI-RS scrambling ID, QCL information, or the like. The feedback configuration information includes channel estimation priority order information of a plurality of channels. The Type-S CSI-RS configuration may include information about an order of estimating CSI for each channel, so as to obtain CSI of all channels in a wireless communication system using a SN. The information about an order of estimating CSI for each channel may be determined according to the structure of the SN determined in operation S1630.

Afterward, Phase 2 may be performed via operation S1650 to operation S1690. In Phase 2, the BS supports multiple accesses of the plurality of UEs, based on SA allocation and SN structure for each UE which are determined in Phase 1.

In operation S1650, the BS transmits a Type-S CSI-RS to the plurality of UEs. An operation in which the BS transmits the Type-S CSI-RS to the plurality of UEs may be divided into an operation of transmitting the Type-S CSI-RS configuration information to a corresponding UE and an operation of transmitting the feedback configuration information to a corresponding UE. The UE may identify, based on the Type-S CSI-RS configuration information received in operation S1650, at least one of the number of ports for each CSI-RS, a timing in which each CSI-RS is to be transmitted, a resource location, and transmission power. Also, the UE may perform channel estimation according to a channel estimation priority order of a plurality of channels, based on the feedback configuration information received in operation S1650 (operation S1670). In an embodiment, the feedback configuration information may be included in the Type-S CSI-RS configuration information or may be provided by separate higher layer signaling or control signaling.

In operation S1660, the BS may transmit a PDSCH to the UE so as to support an access of the UE. In an embodiment, operation S1660 may be performed after operation S1680. In this case, the BS may transmit the PDSCH to the UE, based on CSI obtained in operation S1680. For example, according to the CSI determined based on the feedback configuration information and the Type-S CSI-RS, a modulation and coding scheme of the PDSCH may be determined.

In operation S1670, after the UE receives the Type-S CSI-RS, the UE estimates a channel between a transmission antenna of the BS and a reception antenna of the UE, by using the Type-S CSI-RS. The UE may generate, based on the estimated channel, a RI, a PMI, or a CQI, which are feedback information, by using the received feedback configuration information and a predefined codebook.

Afterward, in operation S1680, the UE transmits, to the BS, a plurality of pieces of feedback information (determined CSI) at feedback timing set according to the feedback configuration information.

In operation S1690, the BS may determine whether to perform additional Phase 1, based on CSI reporting received in operation S1680. That is, based on CSI reporting received from the UEs, the BS may determine whether to additionally allocate a SA to at least one UE from among the plurality of UEs and to change a structure of a SN corresponding to the at least one UE. For example, in a case where there is a sharp change in channel states of the UEs whose accesses are supported or a case where CSI to be considered is added as multiple new UEs request an access, the BS may determine that additional Phase 1 is requested.

In a case where it is determined, in operation S1690, that additional Phase 1 is requested or where a preset time is expired, the method may proceed to operation S1611. In operation S1611, the BS may transmit a CSI-RS to each of the plurality of UEs so as to determine SA allocation and SN structure for each UE. Operation S1611 may be performed in a similar manner to operation S1610.

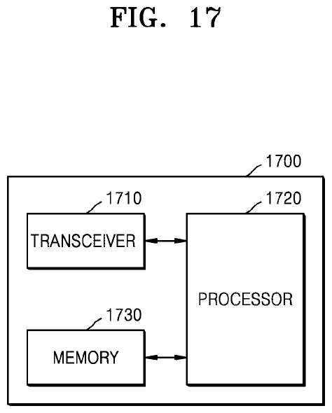

FIG. 17 is a schematic block diagram illustrating a configuration of a BS 1700 according to an embodiment of the present disclosure.

Referring to FIG. 17, the BS 1700 may include a transceiver 1710, a processor 1720, and a memory 1730. According to the aforementioned communication schemes of the BS 1700, the transceiver 1710, the processor 1720, and the memory 1730 of the BS 1700 may operate. However, elements of the BS 1700 are not limited to the example above. For example, the BS 1700 may include more elements than the aforementioned elements or may include fewer elements than the aforementioned elements. In an embodiment, the transceiver 1710, the processor 1720, and the memory 1730 may be implemented as one chip. The processor 1720 may include one or more processors.

A transmitter of the BS 1700 and a receiver of the BS 1700 may be collectively referred to as the transceiver 1710, and the transceiver 1710 may transmit or receive a signal to or from a UE or a network entity. The signal transmitted to or received from the UE or the network entity may include control information and data. To this end, the transceiver 1710 may include a RF transmitter for up-converting and amplifying a frequency of signals to be transmitted, and an RF receiver for low-noise-amplifying and down-converting a frequency of received signals. However, this is merely an example of the transceiver 1710, and thus elements of the transceiver 1710 are not limited to the RF transmitter and the RF receiver.

Also, the transceiver 1710 may perform functions for transmitting and receiving signals via a wireless channel. For example, the transceiver 1710 may receive signals via wireless channels and output the signals to the processor 1720, and may transmit signals output from the processor 1720, via wireless channels.

The memory 1730 may store programs and data necessary for operations of the BS 1700. Also, the memory 1730 may store control information or data which are included in a signal obtained by the BS. The memory 1730 may be implemented as a storage medium including a ROM, a RAM, a hard disk, a CD-ROM, a DVD, or the like, or any combination thereof. Alternatively, the memory 1730 may not be separately arranged but may be included in the processor 1720. The memory 1730 may be configured as a volatile memory, a non-volatile memory, or a combination of a volatile memory and a non-volatile memory. The memory 1730 may provide stored data, in response to a request by the processor 1720.

The processor 1720 may control a series of processes to allow the BS 1700 to operate according to the aforementioned embodiments of the present disclosure. For example, the processor 1720 may receive a control signal and a data signal by using the transceiver 1710, and may process the received control signal and the received data signal. The processor 1720 may transmit the processed control signal and the processed data signal by using the transceiver 1710. Also, the processor 1720 may record data to and read data from the memory 1730. The processor 1720 may perform functions of a protocol stack which are requested by the communication rules. To this end, the processor 1720 may include at least one processor or micro-processor. In an embodiment, a part of the transceiver 1710 or the processor 1720 may be referred to as a communication processor (CP). In an embodiment, the processor 1720 may configure downlink control information (DCI) including allocation information about a PDSCH, and may control each element of the BS 1700 so as to transmit the DCI.

In an embodiment, the processor 1720 may obtain CSI from a plurality of UEs via the transceiver 1710, may identify a plurality of SAs formed from an antenna array having a plurality of antenna elements, may identify at least one SA to be allocated to the plurality of UEs from among the plurality of SAs, may determine a structure of a first SN corresponding to at least one SA to be allocated to a first UE from among the plurality of UEs, may determine a structure of a second SN corresponding to at least one SA to be allocated to a second UE from among the plurality of UEs, and may support multiple accesses of the plurality of UEs, based on the determined structure of the first SN and the determined structure of the second SN.

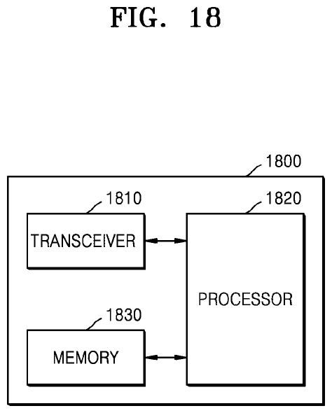

FIG. 18 is a schematic block diagram illustrating a configuration of a UE 1800 according to an embodiment of the present disclosure.

Referring to FIG. 18, the UE 1800 may include a processor 1820, a memory 1830, and a transceiver 1810. However, elements of the UE 1800 are not limited to the example above. For example, the UE 1800 may include more elements than the aforementioned elements or may include fewer elements than the aforementioned elements. In an embodiment, the processor 1820, the memory 1830, and the transceiver 1810 may be implemented as one chip.

The processor 1820 may include one or more processors. In this case, the one or more processors may each be a general-purpose processor such as a central processing unit (CPU), an application processor (AP), a digital signal processor (DSP), or the like, a graphics-dedicated processor such as a graphics processing unit (GPU), a vision processing unit (VPU) or the like, or an AI-dedicated processor such as a neural processing unit (NPU). For example, when each of the one or more processors is the AI-dedicated processor, the AI-dedicated processor may be designed to have a hardware structure specialized for processing of a particular AI model.

Also, the processor 1820 may control a series of processes to allow the UE 1800 to operate according to the aforementioned embodiments of the present disclosure. For example, the processor 1820 may receive a control signal and a data signal by using the transceiver 1810, and may process the received control signal and the received data signal. Also, the processor 1820 may transmit the processed control signal and the processed data signal by using the transceiver 1810. Also, the processor 1820 may control input data to be controlled based on a predefined operation rule or an AI model which are stored in the memory 1830, the input data being derived from the received control signal and the received data signal. Also, the processor 1820 may record data to and read data from the memory 1830. The processor 1820 may perform functions of a protocol stack which are requested by the communication rules. According to an embodiment, the processor 1820 may include at least one processor. In an embodiment, a part of the transceiver 1810 or the processor 1820 may be referred to as a communication processor (CP).

In an embodiment, the processor 1820 may receive Type-S CSI-RS configuration information and feedback configuration information from a BS via the transceiver 1810. The processor 1820 may receive, from the BS via the transceiver 1810, the Type-S CSI-RS generated based on Type-S CSI-RS configuration information. Based on the feedback configuration information and the Type-S CSI-RS, the processor 1820 may determine CSI of a plurality of channels and may transmit the determined CSI of the plurality of channels to the BS via the transceiver 1810.

The predefined operation rule or the AI model may be made through training. The meaning of being made through training indicates that a basic AI model is trained by using multiple training data based on a learning algorithm so as to execute desired characteristics (or purpose), thus making the predefined operation rule or AI model. Such training may be performed by the UE 1800 on which AI according to the present disclosure is implemented or by a separate server and/or a system. Examples of the learning algorithm may include, but are not limited to, supervised learning, unsupervised learning, semi-supervised learning, or reinforcement learning.

The AI model may include a plurality of neural network layers. Each of the plurality of neural network layers has a plurality of weight values, and performs a neural network operation through an operation between an operation result of a previous layer and the plurality of weight values. The plurality of weight values of the plurality of neural network layers may be optimized due to a training result of the AI model. For example, the plurality of weight values may be updated to reduce or minimize a loss value or a cost value obtained by the AI model during a training process. Examples of the AI neural network may include, but are not limited to, a deep neural network (DNN), a convolutional neural network (CNN), a recurrent neural network (RNN), a restricted Boltzmann machine (RBM), a deep belief network (DBN), a bidirectional recurrent deep neural network (BRDNN), and a DQN.

The memory 1830 may store programs and data necessary for operations of the UE 1800. Also, the memory 1830 may store control information or data which are included in a signal obtained by the UE 1800. Also, the memory 1830 may store the predefined operation rule or the AI model which are used by the UE 1800. The memory 1830 may be implemented as a storage medium including a read only memory (ROM), a random access memory (RAM), a hard disk, a compact disc (CD)-ROM, a digital versatile disc (DVD), or the like, or any combination thereof. Alternatively, the memory 1830 may not be separately arranged but may be included in the processor 1820. The memory 1830 may be configured as a volatile memory, a non-volatile memory, or a combination of a volatile memory and a non-volatile memory. The memory 1830 may provide stored data, in response to a request by the processor 1820.

A transmitter and a receiver may be collectively referred to as the transceiver 1810, and the transceiver 1810 of the UE 1800 may transmit or receive a signal to or from a BS or a network entity. The transmitted or received signal may include control information and data. To this end, the transceiver 1810 may include a RF transmitter for up-converting and amplifying a frequency of signals to be transmitted, and an RF receiver for low-noise-amplifying and down-converting a frequency of received signals. However, this is merely an example of the transceiver 1810, and thus elements of the transceiver 1810 are not limited to the RF transmitter and the RF receiver. Also, the transceiver 1810 may receive signals via wireless channels and output the signals to the processor 1820, and may transmit signals output from the processor 1820, via wireless channels.

An embodiment of the present disclosure may be embodied as a computer-readable recording medium, e.g., a program module to be executed in computers, which includes computer-readable instructions. The computer-readable recording medium may include any usable medium that may be accessed by computers, volatile and non-volatile medium, and detachable and non-detachable medium. Also, the computer-readable recording medium may include a computer storage medium. The computer storage medium includes all volatile and non-volatile media, and detachable and non-detachable media which are technically implemented to store information including computer-readable instructions, data structures, program modules or other data.

The disclosed embodiments may be implemented in a software (S/W) program including instructions stored in a computer-readable storage medium.

The computer is a device capable of calling the stored instructions from the storage medium and operating according to the disclosed embodiments in accordance with the called instructions, and may include an electronic device according to the disclosed embodiments.

The computer-readable storage medium may be provided in the form of a non-transitory storage medium. Here, the term ‘non-transitory’ means that the storage medium is tangible and does not refer to a transitory electrical signal, but does not distinguish that data is stored semi-permanently or temporarily on the storage medium.

Furthermore, a control method according to the disclosed embodiments may be provided in a computer program product. The computer program product may be traded between a seller and a purchaser as a commodity.

The computer program product may include an S/W program and a computer-readable storage medium having stored thereon the S/W program. For example, the computer program product may include a product (e.g. a downloadable application) in an S/W program distributed electronically through a manufacturer of an electronic device or an electronic market (e.g., Google Play Store and App Store). For electronic distribution, at least a part of the S/W program may be stored on the storage medium or may be generated temporarily. In this case, the storage medium may be a storage medium of a server of the manufacturer, a server of the electronic market, or a relay server for temporarily storing the S/W program.

The computer program product may include a storage medium of a server or a storage medium of a device, in a system including the server and the device. Alternatively, when there is a third device (e.g., a smartphone) that communicates with the server or the device, the computer program product may include a storage medium of the third device. Alternatively, the computer program product may include an S/W program that is transmitted from the server to the device or the third device or from the third device to the device.

In this case, one of the server, the device, and the third device may perform the method according to the embodiments of the disclosure by executing the computer program product. Alternatively, at least two of the server, the device, and the third device may divide and perform, by executing the computer program product, the method according to the disclosed embodiments.

For example, the server (e.g., a cloud server, an AI server, or the like) may execute the computer program product stored in the server, thereby controlling the device to perform the method according to the disclosed embodiments, the device communicating with the server.

As another example, the third device may execute the computer program product, thereby controlling the device to perform the method according to the disclosed embodiments, the device communicating with the third device. When the third device executes the computer program product, the third device may download the computer program product from the server, and may execute the downloaded computer program product. Alternatively, the third device may perform the method according to the disclosed embodiments by executing a pre-loaded computer program product.

Throughout the specification, the term “unit” may indicate a hardware component such as a processor or a circuit, and/or may indicate a software component that is executed by a hardware configuration such as a processor.

While the present disclosure has been particularly shown and described with reference to the accompanying drawings, in which embodiments of the present disclosure are shown, it is obvious to one of ordinary skill in the art that the present disclosure may be easily embodied in many different forms without changing the technical concept or essential features of the present disclosure. Thus, it should be understood that the embodiments described herein should be considered in a descriptive sense only and not for purposes of limitation. For example, configuring elements that are singular forms may be executed in a distributed fashion, and also, configuring elements that are distributed may be combined and then executed.

The scope of the present disclosure is defined by the appended claims, rather than defined by the aforementioned detailed descriptions, and all differences and modifications that can be derived from the meanings and scope of the claims and other equivalent embodiments therefrom will be construed as being included in the present disclosure.

1. A method, performed by a base station (BS), of supporting multiple accesses of a plurality of user equipments (UEs) by using a switch network (SN) in a wireless communication system, the method comprising:
obtaining channel state information (CSI) from the plurality of UEs;
identifying a plurality of subarrays (SAs) formed from an antenna array having a plurality of antenna elements;
identifying at least one SA to be allocated to the plurality of UEs from among the plurality of SAs;
determining a structure of a first SN corresponding to at least one SA to be allocated to a first UE from among the plurality of UEs;
determining a structure of a second SN corresponding to at least one SA to be allocated to a second UE from among the plurality of UEs; and
supporting the multiple accesses of the plurality of UEs, based on the determined structure of the first SN and the determined structure of the second SN.

2. The method of claim 1, wherein identifying the at least one SA to be allocated to the first UE from among the plurality of SAs comprises identifying the at least one SA to be allocated to the first UE, based on a quality of service (QoS) requested for the first UE.

3. The method of claim 1, wherein
the first SN comprises at least one switch configured to connect at least one SA to at least one radio frequency (RF) chain which are allocated to the first UE, and
the determining of the structure of the first SN comprises determining ON or OFF of the at least one switch comprised in the first SN.

4. The method of claim 1, further comprising:
transmitting, to the first UE, first Type-S channel state information reference signal (CSI-RS) configuration information;
transmitting, to the first UE, feedback configuration information determined based on the structure of the first SN;
transmitting, to the first UE, a first Type-S CSI-RS generated based on the first Type-S CSI-RS configuration information; and
receiving, from the first UE, CSI determined based on the feedback configuration information and the first Type-S CSI-RS,
wherein the first Type-S CSI-RS is transmitted via at least one SA allocated to the first UE.

5. The method of claim 4, wherein the feedback configuration information comprises a channel estimation priority order of a plurality of channels.

6. The method of claim 4, further comprising transmitting, to the first UE, a physical downlink shared channel (PDSCH), according to the CSI determined based on the feedback configuration information and the first Type-S CSI-RS.

7. The method of claim 4, further comprising determining whether to additionally allocate a SA to the first UE and whether to change the structure of the first SN, based on the CSI received from the first UE.

8. A base station (BS) configured to support multiple accesses of a plurality of user equipments (UEs) by using a switch network (SN) in a wireless communication system, the BS comprising:
a transceiver; and
at least one processor,
wherein the at least one processor is configured to:
obtain, via the transceiver, channel state information (CSI) from the plurality of UEs;
identify a plurality of subarrays (SAs) formed from an antenna array having a plurality of antenna elements;
identify at least one SA to be allocated to the plurality of UEs from among the plurality of SAs;
determine a structure of a first SN corresponding to at least one SA to be allocated to a first UE from among the plurality of UEs;
determine a structure of a second SN corresponding to at least one SA to be allocated to a second UE from among the plurality of UEs; and
support the multiple accesses of the plurality of UEs, based on the determined structure of the first SN and the determined structure of the second SN.

9. The BS of claim 8, wherein the at least one processor is further configured to identify the at least one SA to be allocated to the first UE, based on a quality of service (QoS) requested for the first UE.

10. The BS of claim 8, wherein
the first SN comprises at least one switch configured to connect at least one SA to at least one radio frequency (RF) chain which are allocated to the first UE, and
the at least one processor is further configured to determine ON or OFF of the at least one switch comprised in the first SN.

11. The BS of claim 8, wherein the at least one processor is further configured to: via the transceiver,
transmit, to the first UE, first Type-S channel state information reference signal (CSI-RS) configuration information;
transmit, to the first UE, feedback configuration information determined based on the structure of the first SN;
transmit, to the first UE, a first Type-S CSI-RS generated based on the first Type-S CSI-RS configuration information; and
receive, from the first UE, CSI determined based on the feedback configuration information and the first Type-S CSI-RS, and
wherein the first Type-S CSI-RS is transmitted to the first UE via at least one SA allocated to the first UE.

12. The BS of claim 11, wherein the feedback configuration information comprises a channel estimation priority order of a plurality of channels.

13. The BS of claim 11, wherein the at least one processor is further configured to, via the transceiver, transmit, to the first UE, a physical downlink shared channel (PDSCH), according to the CSI determined based on the feedback configuration information and the first Type-S CSI-RS.

14. The BS of claim 11, wherein the at least one processor is further configured to determine whether to additionally allocate a SA to the first UE and whether to change the structure of the first SN, based on the CSI received from the first UE.

15. A user equipment (UE) configured to transmit and receive signals in a wireless communication system, the UE comprising:
a transceiver; and
at least one processor,
wherein the at least one processor is configured to:
receive Type-S channel state information reference signal (CSI-RS) configuration information from a base station (BS) via the transceiver;
receive feedback configuration information from the BS via the transceiver;
receive a Type-S CSI-RS generated based on the Type-S CSI-RS configuration information, from the BS via the transceiver;
determine channel state information (CSI) of a plurality of channels, based on the feedback configuration information and the Type-S CSI-RS; and
transmit the determined CSI of the plurality of channels, to the BS via the transceiver.
